(19) United States
(12) Patent Application Publication
(10) Pub. No.: US 2010/0279061 A1
(43) Pub. Date: Nov. 4, 2010

(54) METHOD OF FABRICATING A REINFORCED MEDIUM FOR ABRASIVE-COATED GRINDING MATERIAL, AND ABRASIVE-COATED GRINDING MATERIAL OBTAINED THEREFROM

(75) Inventor: Thierry Mayade, Paladru (FR)

Correspondence Address: OLIFF & BERRIDGE, PLC, P.O. BOX 320850, ALEXANDRIA, VA, 22320-4850, US

(73) Assignee: Arjowiggins Arches, Arches (FR)

(21) Appl. No.: 12/742,193

(22) PCT Filed: Nov. 26, 2008
(86) PCT No.: PCT/FR2008/052133

§ 371 Date: Jul. 1, 2010

(30) Foreign Application Priority Data
Nov. 26, 2007 (FR) 0759312

(51) Int. Cl. B24D 3/00; B24D 11/02; B32B 5/00; D21F 1/00; D21H 23/00; D21H 17/35; D21H 17/53; D21H 17/55; D21H 17/28; D21H 13/00

(52) U.S. Cl. 428/114; 51/295; 428/196; 428/193; 428/142; 162/232; 162/158; 162/123; 162/168.1; 162/164.7; 162/164.6; 162/175; 162/152; 162/157.1

(57) ABSTRACT

The present invention relates to a machine for fabricating a medium for abrasive-coated grinding material, wherein at least one continuous reinforcing element in the form of a tape or a yarn is introduced continuously during wet formation of the medium.

The field of the present invention is that of media for abrasive-coated grinding material, and also that of fabricating abrasive-coated grinding materials by transforming said media.

The present invention relates to a method of fabricating an abrasive-coated grinding material in which the medium is reinforced by yarns and/or tapes. In the meaning of the invention, the term “abrasive-coated” is used to specify a grinding material comprising a medium having abrasive grains secured on one of its faces.

In one technique for making an abrasive-coated grinding material, a layer of sizing is deposited on one face of the medium (recto face), and then abrasive grains are deposited thereon that are themselves covered in an overlayer of sizing.

In particular the overlayer of sizing may optionally be covered in a top layer of sizing that contains in particular waxes, stearate, in particular zinc stearate, or indeed functional fillers. The purpose is specifically to limit clogging, to improve lubrication, or indeed to limit heating of the abrasive coating while it is in use.

Similarly, other layers performing special functions may be deposited in particular on or between the above-described layers or indeed on the verso face of the medium. In particular, the special function may consist in an antistatic treatment.

The medium may be a paper, a non-woven fabric, a polymer film, a size-finished cloth, or a medium based on vulcanized fibers, it being possible to combine these media so as to obtain better utilization characteristics.

When paper is used, the paper is fabricated from cellulose fibers, possibly mixed with synthetic and/or mineral fibers, and in general it includes a sizing agent and possibly other additives conventionally used in paper making such as wet strength agents. In addition, the medium may include antistatic agents or other substances deposited in the aqueous preparation by coating or impregnation, e.g. a dispersed polymer of the synthetic rubber type for imparting flexibility.

The step referred to as “transformation” serves to obtain an abrasive-coated grinding material from the above-described medium. The transformation is generally performed using the method described below.

The layer of sizing is deposited on the medium by appropriate coating means, e.g. roller coating. This sizing layer, commonly referred to as a “make coat” is a composition that may be made in an aqueous medium or in a solvent medium and that includes a settable adhesive that may be a natural paste such as starch or gelatin, or a synthetic resin such as phenolic, urea formaldehyde, melamine formaldehyde, polyurethane, epoxy, alkyd, acrylic, or polyvinyl alcohol resin, or a mixture of the above-mentioned resins, which adhesive usually has a filler added thereto, in particular a mineral filler such as calcium carbonate, calcium sulfate, or cryolite. It may also include other additives such as plasticizers, dyes, surfactants, in particular wetting agents and antifoaming agents, or antistatic substances.

Abrasive grains are then applied to the still-wet layer of sizing. In particular, they may be deposited by electrostatic deposition or by gravity.

The abrasive grains may be selected in particular from aluminum oxide, silicon carbide, garnet, emery, and boron nitride, as described in patent application EP 0 352 811, or indeed zirconium oxide. In particular, the abrasive grains may be in the form of aggregates made up of agglomerated grains, such aggregates presenting longer lifetime and providing abrasion of more uniform quality.

The person skilled in the art will select the nature of the abrasive grains depending on the type of abrasion that is desired and the part that is to be abraded.

Furthermore, the grain size of the abrasive grains may be selected in particular depending on the surface that is to be abraded and the degree of polish that is desired.

In Europe, abrasive grains are usually classified in terms of a standard set by the FEPA (Federation of European Producers of Abrasives); the grade for an abrasive-coated grinding material is a reference that begins with the letter P followed by a number known as the “grit number”, and the greater this number, the finer the abrasive grains.

Other standards are used in other countries, in particular in the United States of America (ANSI) or in Japan (JIS standard).

It is possible in particular to deposit several different types of abrasive grain in one or more layers.

In a variant, it is possible to deposit the sizing layer and the abrasive grains together, providing they have previously been mixed together.

The medium as coated in this way is subjected to a first drying operation in order to set the settable adhesive.

The first drying operation is generally performed in a festoon dryer or a linear dryer. The drying temperatures and times are selected by the person skilled in the art depending on the nature of the sizing layer. Usually this treatment is performed with temperature and humidity gradients along the dryer; for example, it is possible to dry the sizing layer with abrasive grains for 15 minutes (min) to 45 min at a temperature in the range 65° C. to 115° C. In particular, when using resins in solvent, starch, or gelatin, significantly shorter drying times may be obtained.

The following step consists in depositing an overlayer of sizing, commonly referred to as a “size coat” that comprises compounds of the same type as those mentioned for the sizing layer. The viscosity of the overlayer is generally less than that of the sizing layer so as to encourage it to infiltrate between the abrasive grains without covering them completely. The overlayer of sizing thus serves to enhance the retention of abrasive grains.

The material as obtained in this way is then dried once more and the resin of the overlayer is set completely or in part, depending on the nature of the settable adhesive.

As above, drying temperatures and times depend on the nature of the overlayer; for example it is possible to dry the material for 20 min to 140 min at a temperature in the range 65° C. to 120° C. in a festoon dryer.

In general, after this second drying pass, the resulting material is stored in reels, commonly referred to as “jumbo reels”.

The reels may subsequently be subjected to an additional post-curing step depending on the nature of the settable adhesive used in the sizing layer and overlayer. With thermosetting resins, e.g. such as phenolic resins, the reels are treated so that the sizing layer and overlayer cure as a result of being exposed for several hours, generally 4 hours (h) to 72 h, to a temperature lying in the range about 90° C. to 150° C. In certain special circumstances, the exposure time may be as much as one week.

For settable adhesives that do not require a post-curing step, or baking step, such as urea formaldehyde or epoxy resins, or gelatin, drying and setting are finished by the end of the second drying pass.

It should be observed that depending on the equipment available for the transformation, the first and second drying passes may be performed in two distinct dryers.

The reel as obtained in this way is cooled, e.g. down to 40° C.

After the above severe heat treatment, the verso face of the medium needs to be reconditioned. This operation is performed by unwinding the reel so as to wet it with water optionally containing additives, or with steam, and then winding it back into the form of a reel. The reel is then left untouched for a certain length of time, generally lying in a range a few hours to a few days in order to remoisten and reach equilibrium.

Furthermore, the abrasive material may be subjected in particular to a “flexing” step for making the abrasive coating more flexible in one or more directions. The flexing step may in particular take place before, or after, or simultaneously with the reconditioning step.

In conventional manner, the flexing step is performed by unwinding the jumbo reel and passing the unwound sheet under or over a bar at particular angles and then winding the sheet back into a reel.

Another way of proceeding consists in unwinding the jumbo reel through a pinch zone between a cylinder of large diameter and a cylindrical rod surrounded by a screw thread so as to perform flexing in several directions.

The reels are then possibly cut to the desired format, in particular into the form of disks, sheets, triangles, narrow strips, in particular for use in sanding edge faces, or wide strips, in particular for sanding panels. In particular, the strips may be designed to be assembled together as endless bands.

There exists a need to benefit from abrasive-coated grinding materials in which the medium is reinforced, e.g. in order to present better mechanical strength properties, in particular better tearing strength.

Improved tearing strength provides three advantages. Firstly it serves to solve problems of machineability during the method of fabricating said abrasive-coated grinding material. As a result of said medium for abrasive-coated grinding material being dried and heated as it passes through a dryer, the margin of said medium might suffer cracking, and such cracks give rise in particular to said abrasive-coated grinding material breaking.

Secondly, said cracks constitute defects and give rise to an increase in the number of rejects for poor quality and/or complaints made by clients.

Finally, tear strength is of great interest in final utilization of said abrasive-coated grinding material, in particular when using abrasive bands. Such abrasive bands are sensitive to tearing since they are subjected to high levels of stress, in particular high tension and high speed.

The invention seeks to satisfy those needs in full or in part.

As the medium for an abrasive-coated grinding material, paper is generally preferred because of its low cost, but its poor tearing strength generally limits certain applications to using fabric, for example.

It is also possible to use combinations of fabrics and papers in order to fabricate the medium for an abrasive-coated grinding material, however under such circumstances the cost of the media obtained in that way is increased significantly.

In order to develop reinforced media for abrasive-coated grinding materials, the Applicant has also envisaged mixing synthetic fibers with the cellulose fibers of a paper. However the improvement is partial only and remains insufficient for certain requirements.

In addition, the inventor has observed that the presence of synthetic fibers makes the fabrication method more complex, e.g. because certain members in the fabrication circuits become obstructed. Similarly, synthetic fibers tend to degrade the surface state of the medium as fabricated in this way and in addition, the resulting increase in tear strength is typically accompanied by a significant drop in cohesion and in traction strength. Finally, synthetic fibers generally present a cost that is greater than that of cellulose fibers.

More generally, solutions have been proposed for reinforcing media for abrasive-coated grinding materials with the help of thermoplastic elements. In this context, mention may be made in particular of U.S. Pat. No. 3,166,388, for example.

In order to reinforce media for abrasive-coated grinding materials, proposals have also been made to use an adhesive to stick a strip of filaments on said media. Such a material is described in European patent application EP 1 616 667, and requires an additional fabrication step that is not performed “in line” during fabrication.

U.S. Pat. No. 2,293,246 describes a method of reinforcing a medium for abrasive-coated grinding material by incorporating glass fibers in an already-formed layer or between two already-formed layers of vulcanized fibers.

U.S. Pat. No. 5,830,248 describes a method of reinforcing an abrasive-coated grinding material consisting in sticking a reinforcing yarn by means of an adhesive on an already-formed medium for abrasive-coated grinding material, and then in applying a layer of abrasive to the medium.

The Applicant proposes providing a medium for abrasive-coated grinding material that presents improved mechanical strength and that enables abrasive-coated grinding materials to be made while conserving conventional equipment and methods for making the media for abrasive-coated grinding material. In particular, the fabrication of said media of the invention for abrasive-coated grinding material must not require additional steps over the prior art that cannot be performed in-line, in particular such as a step of sizing with a composition having adhesive properties.

The invention thus provides a method of fabricating an abrasive-coated grinding material comprising a medium of cellulose fibers within which at least one reinforcing element has been introduced, in particular an element in the form of a tape or a yarn, thereby serving in particular to increase the strength of the medium as fabricated in this way, e.g. its tearing strength.

The invention also provides a method of fabricating a medium for an abrasive-coated grinding material in which at least one continuous reinforcing element in the form of a tape or a yarn is continuously introduced during formation of the medium while it is wet.

The invention also provides a method of fabricating a medium for abrasive-coated grinding material, which medium has not been subjected to “vulcanization” treatment in the sense of “vulcanized fibers”, with at least one reinforcing element being introduced continuously into the medium during its formation while wet.

The medium having no vulcanized fibers corresponds to the medium after the reinforcing element has been introduced, in particular to the medium ready for receiving the various layers that enable an abrasive-coated grinding material to be formed.

The invention also provides a method of fabricating an abrasive-coated grinding material comprising a single ply medium having at least one reinforcing element introduced therein, e.g. continuously, in the wet portion of a paper machine while the medium is being formed.

The invention also provides a method of fabricating an abrasive-coated grinding material including a medium that is multi-ply, e.g. two-ply or four-ply, into which at least one reinforcing element is introduced, e.g. continuously, during formation of the medium, while wet. Cohesion between the plies of the medium is developed by uniting them while wet, i.e. by pressing acting on the wet plies, e.g. between cylinders, during fabrication of the medium. Cohesion may be reinforced in particular by spraying an adhesive material prior to uniting the plies while wet, or indeed by impregnating them after they have been united while wet with a solution or a dispersion of a bonding material.

The invention also provides a method of fabricating an abrasive-coated grinding material including a medium into which one or more reinforcing elements are introduced during formation of the medium such that the density per unit length in the transverse direction of the reinforcing elements is greater in the vicinity of the edges of the medium than in its central portion.

By means of the method of the invention, a medium is obtained for abrasive-coated grinding material that presents reinforced tear strength without increasing the mean weight of said medium for abrasive-coated grinding material. Tearing strength may be measured in particular in application of ISO standard 1974:1990 entitled “Determining tear strength (Elmendorf method)” or in application of old standards such as the 1971 ASTM D 827 standard that was canceled and not replaced in 1980, or the 1986 TAPPI T 470-86 standard that was canceled and not replaced in 1996. In the field of paper making, measurement in accordance with the first standard is referred to as “measuring resistance to initiated tearing” since the tearing along an axis perpendicular to the plane of the sample is initiated by means of a standardized notch formed in the sample. In contrast, the two last-mentioned standards are referred to as “measuring resistance to non-initiated tearing”.

Furthermore, the medium of the invention may be fabricated in a conventional installation for fabricating media for abrasive-coated grinding material out of paper, and as a result the economic advantages of paper are conserved.

The invention seeks in particular to take advantage of the strong and reinforced structure presented by the reinforcing element.

The term “reinforcing element” is used to mean an element presenting mechanical properties suitable for imparting sufficient tearing strength to the medium. In particular, tearing strength is improved by at least 30%, and preferably by at least 50%, i.e. the tearing strength as measured in application of ISO standard 1974:1990 on the reinforced medium for abrasive-coated grinding material is greater than the tearing strength as measured in accordance with ISO standard 1974:1990 on the same medium for coating an abrasive but without reinforcing elements.

The term “same medium” should be understood as meaning a medium of the same composition, weight, and dimensions.

By way of example, the reinforcing element may be a reinforcing yarn or tape.

The term “yarn” is used to mean a continuous elongate element, possibly itself made up of a plurality of filaments. In particular, the terms “yarn” and “filament” are used in their textile meaning. The yarn may be on a reel, for example.

The yarn may for example be made of metal (i.e. constituted by wire).

The term “tape” is used to mean a flat elongate element that may in particular be a strip. The tape may be obtained by weaving, by extrusion, or by being cut from a fabric or a film. In particular, the textile meaning of the term “tape” is used. The term “tape” may also cover a strip.

By way of example the reinforcing elements may be woven with one another. They may also form a knit or a net.

In a variant, the reinforcing elements need not be woven together, e.g. as described in example implementations of the invention. In particular, these elements need not be a knit or a net.

A reinforcing element, a yarn or a tape, of the invention may for example be made of a material selected from the following list: cloth, cotton, wool, polyethylene, polypropylene, acrylic, viscose, polyester, polyamide, polyaramid, paper, starch, or a plastics film, in particular of polyester, of cellulose acetate, of polyamide, of metal, or of a metal alloy, etc.

In order to determine the improvement in tearing strength, a comparison is made in particular between tearing strength in a direction perpendicular to the orientation of said reinforcing element(s), and tearing strength in the same direction but in a zone that is free from reinforcing elements. In particular, when the medium is made of paper, said direction is commonly known as the “crosswise”.

The reinforcing element may be of various shapes, in particular concerning its section. In particular, it may have a section that is circular, polygonal, rectangular, or indeed multi-lobed, etc.

The small dimensions of the reinforcing element(s) in the form of yarn or tape, in particular their small width compared with the dimensions of the medium, may enable reinforcement to be applied to the zone(s) of the medium that is/are subjected to the highest stresses, thereby saving on material and placing the reinforcing element(s) only “locally” in the medium and not over the entire surface area of the medium.

For the section of a yarn and for the thickness of a tape, the dimensions of the reinforcing elements may lie in the range 1 micrometer (μm) to 100 μm, and preferably in the range 20 μm to 60 μm; the width of a tape may lie in the range 10 μm to 20 millimeters (mm), and preferably in the range 1 mm to 15 mm.

Advantageously, the reinforcing element thus does not occupy the entire area of the medium. The reinforcing element need be over only a fraction of the area of the medium, in particular in the vicinity of the edges of the medium.

The reinforcing element may extend between two opposite edges of the medium, in particular lengthwise, parallel to its travel direction through the paper machine.

The reinforcing element may be unwound into the medium to enable it to be introduced therein. Under such circumstances, it needs to be fabricated beforehand.

The reinforcing element may equally well be fabricated simultaneously with fabrication of the medium for abrasive-coated grinding material, immediately prior to being introduced into the medium. In particular, the reinforcing element may be fabricated by extruding filaments or strips, in particular by means of dies.

When the medium has a plurality of reinforcing elements, the reinforcing elements may all have the same orientation. In particular, the reinforcing elements may extend through the medium in parallel directions.

The medium may have at least two, or four, or six, or more reinforcing elements.

The reinforcing elements may be disposed at a mutual spacing that is constant or that varies, for example lying in the range 2 mm to 3 meters (m). The reinforcing elements need not be connected to one another.

The reinforcing elements may be spaced apart from each of the faces of the medium. In particular, the reinforcing elements need not come flush with either of the faces of the medium, or need not be located even in part on the surface of either of the faces of the medium.

The reinforcing elements need not cross one another.

The reinforcing elements may appear symmetrically in the medium about a central axis passing through the middle of the width of the medium, parallel to its direction of travel through the paper machine.

All of the reinforcing elements of the medium may be yarns, or in a variant they may be tapes, or in another variant they may be both yarn and tape.

The crosswise density per unit length of the reinforcing elements in the medium may be obtained by the number of reinforcing elements divided by the width of the medium, said width being measured perpendicularly to its travel direction through the paper machine. The crosswise density of the reinforcing elements may be greater in the vicinity of the edges of the medium than in the central portion of the medium.

The reinforcing element may be of a thickness that is less than that of the medium. This thickness may also be greater than or equal to 5%, or 10%, or 20%, or 50% of the total thickness of the medium, reinforcing element(s) included.

The medium may include one or more security elements, or it may have none.

The reinforcing elements may also include one or more security elements, or they may have none.

In particular, the medium and/or the reinforcing elements may be free from any metal plating, magnetic elements, inscriptions or mentions, tracers, in particular nanometric tracers, security fibers, in particular metal security fibers, in particular fibers that are metallic, magnetic, or absorbent or excitable in the ultraviolet, in the visible, or in the infrared, etc.

The reinforcing elements need occupy only a fraction of the area of the medium. Said reinforcing elements may include an agent, in particular on their surfaces, e.g. an agent enhancing adhesion in the medium. This applies in particular to a surface binder commonly used in the following fields; paper making; textile industry; plastics film production; and more particularly a hot-melt agent.

The reinforcing element is preferably introduced in the wet stage while the medium for abrasive-coated grinding material is being formed, i.e. “in-line”, the medium being fabricated in a conventional manner for fabricating a sheet of paper.

In particular, the reinforcing element may be introduced into the bulk of a ply or between two plies that are united together while wet. The medium may be fabricated by means of a flat bed fourdrinier machine and/or a single-ply or multi-ply cylinder vat machine.

The medium may thus be single-ply or multi-ply.

The reinforcing element may be introduced in contact with the forming wire of a paper machine prior to forming the medium, in the fiber suspension, or outside it.

In a particular example of the invention and so as to avoid creating extra thicknesses, the reinforcing element may be introduced with a small amount of oscillation in the transverse direction, i.e. perpendicularly to the fabrication direction of said medium and the unwinding of said reinforcing element. This is particularly important in the field of producing media for abrasive-coated grinding material since the presence of extra thicknesses gives rise to grinding or sanding that is irregular when said abrasive-coated grinding materials are used, and consequently gives rise to scratching. The present invention thus has the advantage of providing a medium for abrasive-coated grinding material without extra thicknesses, unlike prior art solutions that consist in using adhesives to stick a reinforcing element onto said medium for abrasive-coated grinding material.

The medium for abrasive-coated grinding material is plane in shape, e.g. it may be in the form of a sheet. The medium for abrasive-coated grinding material may also include organic fibers, in particular cellulose fibers, synthetic fibers, in particular fibers of polyester, polyimide, viscose, polyaramid, or polyvinyl alcohol; and/or inorganic fibers, in particular glass fibers. Furthermore, the medium for abrasive-coated grinding material may in particular include one or more layers made of fibers such as those described above. In particular, it may comprise a mixture of fibers such as those described above.

The fiber material of the medium may comprise cellulose fibers only, in particular non-modified natural cellulose fibers. In particular, the medium need not have been subjected to “vulcanization” treatment in the sense of “vulcanized fibers”.

The medium need not include synthetic fibers. The medium may in particular be a paper based on natural cellulose fibers.

The medium may include paper-making fibers throughout its thickness.

In the invention, the medium may include additives commonly used in formulations in the paper-making field. These comprise in particular additives commonly used when producing media for abrasive-coated grinding material, in particular wet-and-dry strength agents such as starch, carboxymethyl cellulose, polyvinyl alcohol, guar gum, polyacrylamides, or gelatin, and/or wet strength agents such as synthetic latex (mixture in a colloidal dispersion), urea formaldehyde, melamine formaldehyde, polyamine-amide-epichlohydrine (PAAE), isocyanate, or alkyd resin.

Said medium may also be subjected to sizing, antistatic, flexing, or coloring treatment, among others.

In particular, the additives are added in the bulk of the medium or by impregnating the medium after it has been formed.

The medium of the invention may present weight lying in the range 50 grams per square meter (g/m²) to 1000 g/m², and preferably in the range 80 g/m² to 600 g/m².

The method of fabricating an abrasive-coated grinding material of the invention may also include the steps consisting in:
producing a medium for abrasive-coated grinding material that includes at least one reinforcing element introduced during said fabrication;
depositing a sizing layer on one face of the medium obtained by the fabrication method of the invention;
depositing abrasive grains on the sizing layer;
depositing an overlayer of sizing on the abrasive grains;
optionally, depositing a top layer of sizing on the overlayer; and
optionally depositing one or more layers performing a special function, in particular consisting in an antistatic treatment, on or between the layers.

The sizing layer and the abrasive grains may be deposited together on the medium providing they are mixed together beforehand.

The invention also provides a medium for abrasive-coated grinding material in which at least one reinforcing element has been introduced, in particular in tape or yarn form.

The medium for abrasive-coated grinding material may optionally comprise cellulose fibers only.

The invention also provides a medium for abrasive-coated grinding material, the medium comprising paper-making fibers throughout its thickness with one or more continuous reinforcing elements in tape or yarn form being introduced therein. In particular, the medium is not subjected to “vulcanization” treatment in the sense of “vulcanized” fibers.

The invention also provides a medium for abrasive-coated grinding material in which one or more reinforcing elements is/are introduced such that the density per unit length in the transverse direction of the reinforcing element is greater in the vicinity of the edges of the medium than in its central portion.

The invention also provides a medium for abrasive-coated grinding material, the medium comprising fibers, in particular such as those described above, throughout its entire thickness, and having one or more reinforcing elements introduced therein that extend between two opposite edges of the medium. In particular, the medium has not been subjected to “vulcanization” temperature in the “vulcanized fibers” sense.

The invention also provides a medium for abrasive-coated grinding material, the medium comprising fibers, in particular such as those described above, throughout its thickness, and having a plurality of reinforcing elements introduced therein that all extend in the same direction. In particular, the medium has not been subjected to “vulcanization” temperature in the sense of “vulcanized fibers”.

The medium may be as described above.

In another of its aspects, the invention also provides an abrasive-coated grinding material comprising:
a medium as defined above;
a layer of sizing deposited on one of the faces of the medium;
abrasive grains deposited on the layer of sizing;
an overlayer of sizing deposited on the abrasive grains;
optionally a top layer of sizing deposited on the overlayer of sizing; and
optionally one or more layers performing a special function, in particular consisting in antistatic treatment, and disposed on or between said layers of the abrasive-coated grinding material.

The invention can be better understood on reading the following description of non-limiting embodiments of the invention and on examining the accompanying drawings, in which:

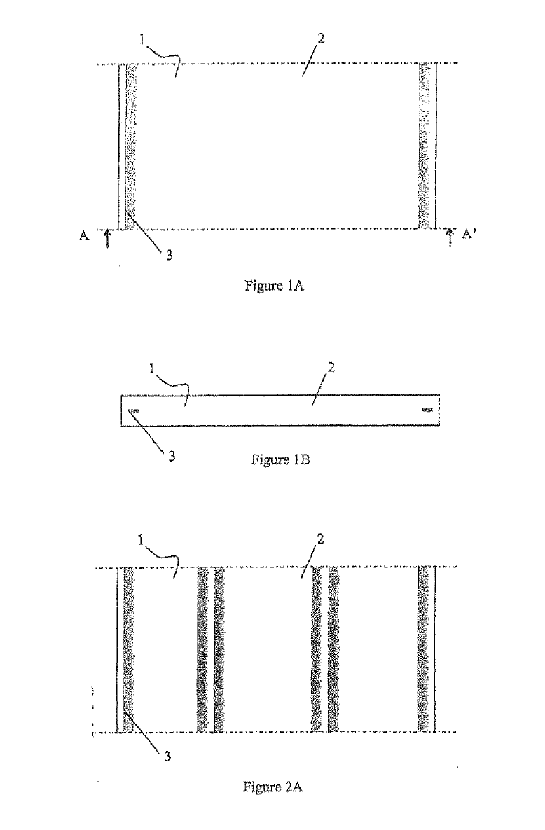

FIG. 1A is a diagrammatic and fragmentary view of an example medium for abrasive-coated grinding material in accordance with the invention;

FIG. 1B is a diagrammatic and fragmentary view of the FIG. 1A medium looking along AA′;

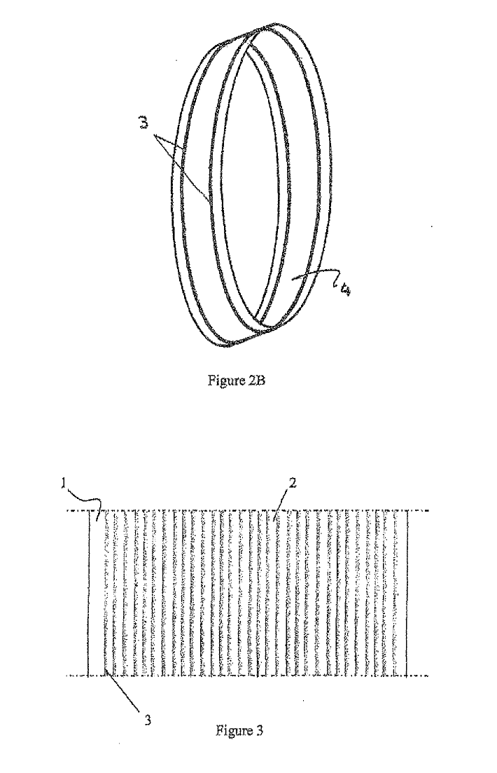

FIG. 2A is a diagrammatic and fragmentary view of another example medium for abrasive-coated grinding material in accordance with the invention;

FIG. 2B is a diagrammatic perspective view of an example of an abrasive band obtained from the FIG. 1B medium; and

FIG. 3 is a diagrammatic and fragmentary view of another example medium for abrasive-coated grinding material in accordance with the invention.

### EXAMPLE 1 OF THE INVENTION

During fabrication of a medium for abrasive-coated grinding material in the prior art manner on a flat bed fourdrinier machine with an effective width of 166 centimeters (cm), two polyester tapes presenting a thickness of 26 μm and a width of 3 mm, as obtained by cutting a polyester film are introduced above the flat bed. Bach tape is situated at 0.5 cm from the edge of said medium for abrasive-coated grinding material that is being formed, i.e. at positions of 0.5 cm and 165.5 cm across said effective width. This introduction is performed using two unwinders placed above the flat bed.

After said medium for abrasive-coated grinding material has been dewatered, pressed, and then dried, a medium for abrasive-coated grinding material of the invention is obtained that presents a weight of 120 g/m² and a thickness of 149 μm. The edges of said medium for abrasive-coated grinding material as fabricated in this way present increased tear strength and therefore do not crack during the transformation of said medium for abrasive-coated grinding material (depositing grains and various layers of resin, as described above).

The grinding medium obtained in this way by transformation may then be trimmed over 2.5 cm and cut to the desired format (sheets having a standard format of 23 cm×28 cm, (i.e. seven widths across the trimmed machine width) so as to obtain prior-art abrasive sheets. In particular, these sheets have no reinforcing elements.

### EXAMPLE 2 OF THE INVENTION

During fabrication of a medium for abrasive-coated grinding material in the prior art manner on a two-ply paper machine with two former cylinders with an effective width of 135 cm, twenty-four polyester tapes having a width of 5 mm and a thickness of 26 μm are introduced between the two plies immediately prior to their being united while wet (pressing two fiber mats together immediately before dewatering them). Said tapes are located at the following positions across the effective machine width: 1, 11, 13, 23, 25, 35, 37, 47, 49, 59, 61, 71, 73, 83, 85, 95, 97, 107, 109, 119, 121, 131, 133, and 143 centimeters.

After said medium for abrasive-coated grinding material has been dewatered, pressed, and then dried, a medium for abrasive-coated grinding material of the invention is obtained having a weight of 250 g/m² (two plies each of 125 g/m²) and a thickness of 298 μm. Said medium for abrasive-coated grinding material as fabricated in this way presents increased tear strength and consequently better machineability while it is being transformed and while it is being used. The abrasive-coated grinding material as obtained in this way is cut into twelve strips of 12 cm×700 cm so that each abrasive strip is provided with two reinforcing tapes extending lengthwise and at a distance of 1 cm from each edge.

Each of said strips is then assembled together end to end, using the usual techniques of the prior art so as to form an endless band, in particular by using an adhesive tape. Said abrasive band as obtained in this way presents increased durability because of the reinforcing elements situated in its margins.

While abrasive bands are in use, their edges are subjected to high levels of stress and constitute zones of weakness. Thus, the presence of reinforcing elements in the margins serves to reduce the risk of abrasive bands of the invention rupturing, thereby improving their durability.

### EXAMPLE 3 OF THE INVENTION

During fabrication of a medium for abrasive-coated grinding material in the prior art manner on a two-ply paper machine with two former cylinders with an effective width of 144 cm, a mixture of 500 80 decitex (dtex) yarns of polyimide and viscose (mixture) is introduced in the cylinder vat of the first ply. Said yarns are wound in the machine direction and they are uniformly distributed across said effective machine width.

After said medium for abrasive-coated grinding material has been dewatered, pressed, and dried, a medium for abrasive-coated grinding material of the invention is obtained presenting weight of 342 g/m² (two plies of 171 g/m²) at a thickness of 430 μm. Said medium for abrasive-coated grinding material as fabricated in this way presents increased tear strength and consequently machineability while it is being transformed and while it is in use. The abrasive-coated grinding material as obtained in this way is trimmed and then cut to the desired format so as to obtain abrasive sheets or strips including reinforcing elements.

Said reinforcing elements give the medium for abrasive-coated grinding material increased strength and said abrasive sheets or strips obtained by the method of the invention thus have greater durability than abrasive sheets or strips of the prior art.

FIG. 1A shows a medium 1 for abrasive-coated grinding material and in accordance with Example 1 of the invention, including two reinforcing tapes 3 that extend between two opposite edges of the medium 1 and that are situated close to the other two edges of the medium 1. The thickness, the width, and the length of each of the reinforcing tapes 3 may be varied.

FIG. 1B is a view looking along AA′ showing the FIG. 1A medium 1 for abrasive-coated grinding material.

The presence of reinforcing tapes 3 at the periphery of the medium 1 makes it possible in particular to impart increased tear strength to the medium 1 at its periphery, thus making it possible for example to avoid cracking while the medium 1 for abrasive-coated grinding material is being transformed. The central zone 2 that does not have any reinforcing tape is comparable to a medium for abrasive-coated grinding material as applied in the prior art and it does not present increased tearing strength.

FIG. 2A shows a medium 1 for abrasive-coated grinding material in accordance with the invention, having six reinforcing tapes 3 extending between two opposite edges of the medium 1 and situated close to the other two edges of the medium 1. The thickness, the width, and the length of each of the reinforcing tapes 3 may be varied.

FIG. 2B shows a band 4 constituted by one of the three abrasive strips fabricated from the medium for abrasive-coated grinding material of the invention as shown in FIG. 2A.

FIG. 3 shows another example of a medium for abrasive-coated grinding material that includes a plurality of reinforcing tapes 3 extending between two opposite ends of the medium 1 and distributed in substantially equidistant manner across the width of the medium 1. The presence of reinforcing tapes 3 over the entire surface of the medium 1 for abrasive-coated grinding material, including in its central zone 2, imparts increased tearing strength at all points of the medium 1, e.g. providing it with better machineability while it is being transformed and while it is being used.

The thickness, the length, and/or the width of each of the reinforcing tapes 3 may be identical or different. The spatial disposition of each of the reinforcing tapes 3 may likewise be varied.

Throughout the description, the term “comprising a” should be understood as being synonymous with “comprising at least one”, unless specified to the contrary.

1. A machine for fabricating a medium for abrasive-coated grinding material, wherein at least one continuous reinforcing element in the form of a tape or a yarn is introduced continuously during wet formation of the medium.

2. A method of fabricating a medium for abrasive-coated grinding material that has not been subjected to vulcanization treatment, wherein at least one reinforcing element is introduced continuously during wet formation of the medium.

3. A method according to claim 2, the reinforcing element being a yarn or a tape.

4. A method according to claim 1, the medium comprising cellulose fibers.

5. A method according to claim 1, the reinforcing element being unwound during introduction into the medium.

6. A method according to claim 1, the reinforcing element extending between two opposite ends of the medium.

7. A method according to claim 1, the medium including at least two reinforcing elements.

8. A method according to claim 1, the reinforcing element being placed at constant mutual spacing.

9. A method according to claim 1, the reinforcing elements being placed at varying mutual spacing.

10. A method according to claim 1, the reinforcing element(s) being present only in the vicinity of the edges of the medium.

11. A method according to claim 1, the medium not having been subjected to vulcanization treatment.

12. A method according to claim 1, the medium being a single ply and the reinforcing element being introduced in the wet portion of a paper machine.

13. A method according to claim 1, the medium being multi-ply, cohesion between the plies of the medium being developed by being united while wet.

14. A method according to claim 1, the medium including a plurality of reinforcing elements, the density per unit length in the transverse direction of the reinforcing elements being greater in the vicinity of the edges of the medium than in the central portion of the medium.

15. A method according to claim 1, the reinforcing element being constituted by a material selected from the following list: fabric, cotton, wool, polyethylene, polypropylene, acrylic, viscose, polyester, polyamide, polyaramid, paper, starch, and a film of plastics material, of polyester, cellulose acetate, polyamide.

16. A method according to claim 1, the section of the reinforcing element being circular, polygonal, rectangular, or multi-lobed.

17. A method according to claim 1, the reinforcing element including an agent, on its surface enhancing its adhesion in the medium.

18. A method according to claim 1, the medium comprising organic, synthetic, and/or mineral fibers.

19. A method according to according to claim 1, the medium having been subjected to sizing, antistatic, softening, or coloring treatment.

20. A method according to claim 1, the medium being a sheet and possessing weight lying in the range 50 g/m² to 1000 g/m².

21. A method according to claim 1, further comprising the steps consisting in:
depositing a sizing layer on one face of said medium;
depositing abrasive grains on said sizing layer;
depositing an overlayer of sizing on said grains;
optionally depositing a top layer of sizing on said overlayer; and
optionally depositing one or more layers performing a special function on or between said layers.

22. A medium for abrasive-coated grinding material, which has not been subjected to vulcanization treatment, the medium comprising fibers throughout its thickness and having one or more continuous reinforcing elements in tape or yarn form introduced therein.

23. A medium for abrasive-coated grinding material, having one or more reinforcing elements introduced therein such that the density per unit length in the transverse direction of the reinforcing elements is greater in the vicinity of the edges of the medium than in its central portion.

24. A medium for abrasive-coated grinding material, which medium has not been subjected to vulcanization treatment, comprising paper-making fibers throughout its thickness and having one or more reinforcing elements extending between two opposite edges of the medium introduced therein.

25. A medium for abrasive-coated grinding material, which medium has not been subjected to vulcanization treatment, comprising paper-making fibers throughout its thickness and having one or more reinforcing elements all extending in the same direction introduced therein.

26. A medium according to claim 23, the reinforcing element(s) being in the form of a tape or a yarn.

27. A medium according to claim 22, the medium comprising cellulose fibers.

28. A medium according to claim 22, the reinforcing element(s) not including any security elements.

29. A medium according to claim 22, the medium not including any security elements.

30. A medium according to claim 22, the reinforcing element(s) being present only in the vicinity of the edges of the medium.

31. A medium according to claim 22, the reinforcing elements being disposed at constant mutual spacing.

32. A medium according to claim 22, the reinforcing elements being disposed at varying mutual spacing.

33. A medium according to claim 22, the medium including at least two reinforcing elements.

34. A medium according to claim 22, the reinforcing elements being disposed in the medium symmetrically about a central axis passing along the middle of the width of the medium, parallel to its travel direction in a paper machine.

35. Abrasive-coated grinding material comprising:
a medium according to claim 22;
a layer of sizing deposited on one of the faces of the medium;
abrasive grains deposited on the layer of sizing;
an overlayer of sizing deposited on the abrasive grains;
optionally a top layer of sizing deposited on the overlayer of sizing; and
optionally one or more layers performing a special function, and disposed on or between said layers of the abrasive-coated grinding material.
